(19) United States
(12) Patent Application Publication
(10) Pub. No.: US 2010/0008495 A1
(43) Pub. Date: Jan. 14, 2010

(54) KEYBOARD WITH INTEGRATED TELEPHONE SERVICE

(75) Inventor: Athos Bulgari, Amparo (BR)

Correspondence Address: OSHA LIANG L.L.P., TWO HOUSTON CENTER, 909 FANNIN, SUITE 3500, HOUSTON, TX, 77010, US

(73) Assignee: LEGALSOFT PARTICIPACOES, COMERCIO E. SERVICOS DE TELECOMUNICACOES LTDA, Sao Paulo (BR)

(21) Appl. No.: 12/361,272

(22) Filed: Jan. 28, 2009

(30) Foreign Application Priority Data
Jul. 8, 2008 (BR) PI 0802411-1

(51) Int. Cl. H04M 1/00

(52) U.S. Cl. 379/436

(57) ABSTRACT

The present invention relates to a keyboard that can be coupled to external equipment connectable to a communication network compatible with the Internet Protocol. The keyboard includes at least keys for sending commands to the external equipment; an interface unit for coupling the keyboard to the external equipment; a main control unit operatively associated with the keys, a means for receiving sound, a means for emitting sound, the interface unit, and a data storage unit. The data storage unit having firmware and communication software that can be automatically run by the main control unit when the keyboard is coupled to the external equipment, said firmware for providing identification of the keyboard by the external equipment. The communication software having an algorithm for voice over Internet Protocol that allows a real time conversation between a user of the keyboard and at least one other user of the communication network.

### CROSS-REFERENCE TO RELATED APPLICATIONS

This application claims priority, under 35 U.S.C. §119, to Brazilian Patent Application No. PI 0802411-1 filed Jul. 8, 2008, entitled “KEYBOARD WITH INTEGRATED TELEPHONE SERVICE.”

### TECHNICAL FIELD

The present invention relates to a computing device with integrated telephone service. More particularly, this invention relates to a keyboard, for using on a computer connected to the Internet, which allows a telephone conversation between the user and at least one other user of the network.

### BACKGROUND

In the field of computers, keyboards are peripheral devices or accessories that allow the typing of texts and sending of commands by a user to a main equipment, such as a computer. The first keyboards developed simulated a conventional typewriter and allow only the typing of letters, numbers and characters. With the technological development, keyboards began to acquire additional functions mainly for multimedia applications (audio and video), games and graphical editor applications. Currently, the keyboards are equipped with shortcut keys for quick access to enable a simplified and fast interaction of user with the computer operating system and/or with their programs (software) installed, such as text-editing programs and e-mail management.

This keyboard breakthrough has occurred alongside to the development of computer technology as a whole, not only with regard to peripherals, accessories and hardware in general, but also with respect to the communication means between computers. In this sense, the advent of the global information network, Internet, has enabled a new form of interaction between computers users, allowing various technological innovations in the field of computer technology.

In particular, the development of the VoIP technology—Voice over IP (Voice over Internet Protocol) and the availability of a high speed of browsing on the network (“Broadband”) allowed the telephone conversation between users connected to the Internet using their own resources provided by the web. This represented a considerable reduction in costs for conventional phone calls, especially long distance calls. Alongside to these achievements, several computer programs have been developed to provide users with phone call service using VoIP technology.

Today, there are already on the market IP phones of the type “stand alone”, that is, independent telephone devices that use Voice over IP technology and do not require the use of computers for their operation. These IP phones are connected directly to the Internet, and its software enables the receipt and connection of telephone calls via the Internet as well as the conversation of its users.

However, many users already have a conventional phone and see no need to replace it with an IP phone of the type “stand-alone” because of its high cost, in addition to the installation inconvenience and, for example, the installation of network points.

In view of this, special keyboards have been developed that combine the functions of conventional typing and multimedia applications with telephony functions based on VoIP technology.

However, these known keyboards are dependent on the computers on which they are connected, so that the user is required to install an specific communication software on the computer for performing the telephone service.

Thus, it is not seen a real “plug and play” operation, and, whenever the user wishes to use the telephone resources of the keyboard on a different computer, it is necessary to install the communication software using a CD/DVD, USB flash drive, floppy, “download” of the Internet, etc. This requirement limits the usability of the keyboard, restraining its portability and “plug and play” use on any computer.

### OBJECT OF THE INVENTION

The object of this invention is to provide a keyboard for use with equipment/device/apparatus connectable to a communication network compatible with the Internet Protocol, capable of allowing connection/receipt of phone calls in addition to telephone conversations between its users and at least one other user of the network, without requiring the installation of a dedicated computer program in the equipment/device/apparatus.

### SUMMARY

The object of this invention is achieved through the provision of a keyboard that can be associated with an external device connectable to a communication network compatible with the Internet Protocol. This keyboard includes keys capable of enabling the transmission of commands to external equipment. The keyboard is also provided with at least means for receiving sound, means for emitting sound, an interface unit that allows the coupling of the keyboard to the external equipment, a main control unit operatively associated with the keys, to the means for receiving sound, to the means for emitting sound and to the interface unit and a data storage unit operatively associated with the main control unit. Said data storage unit is equipped with a firmware and a communication software automatically executable by the main control unit when the keyboard is coupled to the external equipment. Said firmware is capable of providing the identification of the keyboard by the external equipment. Said communication software has an algorithm for voice over Internet Protocol that allows a conversation in real time between a user of the keyboard and at least one other user of the communication network.

### BRIEF DESCRIPTION OF THE DRAWINGS

This invention will be described in greater details below, with reference to the attached drawings, in which:

FIG. 1 is a block diagram of a keyboard with integrated telephone service, object of this invention.

FIG. 2 represents a schematic view from above of the keyboard showed in FIG. 1.

FIG. 3 is a schematic rear view of the keyboard showed in FIG. 1.

FIG. 4 represents a schematic side view of the keyboard shown in FIG. 1.

### DETAILED DESCRIPTION

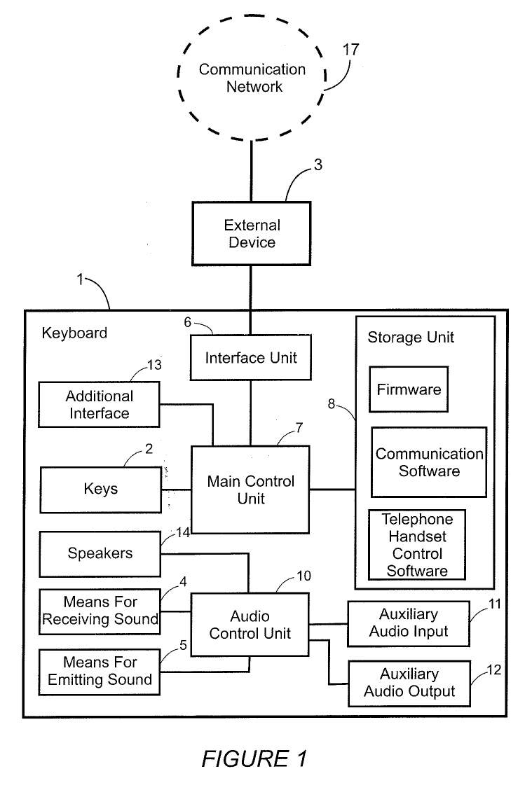

FIG. 1 illustrates a block diagram of a keyboard 1 with integrated telephone service in accordance with a preferred embodiment of this invention.

The keyboard 1 can be coupled to an external equipment 3 connected to a communication network 17 compatible with the Internet Protocol. This communication network comprises, preferably, a public information network as the global network Internet. Optionally, it is also possible to use a private information network as an Intranet, provided that it is compatible with the Internet protocol. As already known to the prior art, the access to these networks can be made with any technology that uses wires and cables (ISDN, ADSL, Cable Modem, etc.) or free of them (radiofrequency, satellite, mobile telephone network, etc).

The external equipment 3 comprises preferably a desktop computer or a notebook. Thus, the keyboard 1 includes keys 2 set up similarly to a conventional keyboard for use with home computers. Thus, the keys 2 are capable of allowing the transmission of commands to external equipment 3. The specific configuration of the format of the keyboard 1 and the arrangement of the keys 2 can vary depending on the conveniences and needs of use and are irrelevant to defining the scope of protection of this invention.

Alternatively, other types of external equipment 3 may be used, such as a mobile phone, a PDA (hand-held), a Smartphone or any other equipment/device/hardware capable of connecting to a network compatible with the Internet Protocol. The external equipment 3 can run on an operating system like Windows, Linux, MAC OS X or any other compatible system.

It is expected that the external equipment 3 is the device itself for direct connection to the Internet, such as an ADSL modem.

As shown in FIG. 1, the connection between the keyboard 1 and the external equipment 3 is made by a interface unit 6 comprised by the keyboard 1. This interface unit 6, preferably, compatible with the USB standard (1.1 and/or 2.0) or PS2, is associated with a connection cable 16 with a standard USB or PS2 end, which in turn, is configured to fit in a connection compatible with the external equipment 3. The interface unit 6 can also be compatible with a wireless communication standard, such as Bluetooth, zigbee, Wi-Fi, etc. Additionally, the interface unit 6 can comprise a connector RJ45 (Ethernet), 1 so that the keyboard can be connected directly to an ADSL modem or to an external network adapter, allowing its direct connection to the Internet without a computer.

The keyboard 1 may also include a plurality of interface unit 6 of several standards such as those above mentioned, providing a broad range of use options for its user.

When the interface unit 6 consists of an interface of the type USB 2.0, the external equipment 3 provides power to the keyboard 1. But when another type of interface unit 6, which is not suitable for the supplying power by the external equipment 3, is used, it is necessary to connect an external power supply (e.g. an AC source) or an internal power source (e.g. battery) in the keyboard 1.

The interface unit 6 is operatively associated to a main control unit 7 which consists of a chip of a microcontroller or microprocessor.

The main control unit 7 is also associated operatively to a data storage unit 8 having a firmware automatically executable by the main control unit 7 when the keyboard 1 is coupled to the external equipment 3. This firmware is a software that is able to provide the identification of the keyboard 1 at external equipment 3.

The data storage unit 8 also includes a communication software that is also automatically executable by the main control unit 7 when the keyboard 1 is coupled to the external equipment 3. This communication software has an algorithm for voice over Internet Protocol that allows a conversation in real time between a user of the keyboard 1 and at least one other user of the communication network 17.

The technology and auto-running algorithm of software in general are already well-known in the state of the art and will not be detailed here. For example, software installation CDs and DVDs for the operating system Windows are usually auto-running when inserted into a CD/DVD reader of the computers (the CD/DVD contains a file named Autorun.exe).

It should be noted that an automatic execution is not mandatory, so that if you want to disable it, this option will be available. In this case, the user must enable the communication software manually using the browser of the operating system installed in the external equipment 3.

The communication software, when running, provides a graphical user interface to be displayed on a screen (display) of the external equipment 3. This graphical interface is displayed automatically when the keyboard 1 is coupled to the external equipment 3. In a variation of the present invention, the keyboard 1 is equipped with an output connector for external monitors so that, when the keyboard 1 is directly connected to an ADSL modem or to an external network adapter, the user can view the graphical interface.

The communication software may include other functions, such as setting panel, interactive login, customized portal, browser, online help, volume indicator and control, RSS reader, radio, network status, an indicator of voice mail, indicator of privacy filter, an indicator of audio traffic and any phone functions, such as caller identification, caller's information, call's duration, call barring, missed calls, incoming calls or outgoing calls, redial, call forwarding, etc.

Thus, different from the keyboards known in the state of the art, in the keyboard 1 of the present invention, the firmware and the communication software are already installed in advance during manufacture, so as to avoid the need to install specific programs by users in the external device 3 (e.g. computer) via CD/DVD, “download”, flash drive, floppy, etc.

Therefore, the keyboard 1 provides a full “plug and play” solution, that is when the user connects the keyboard 1 in any computer or equipment/device/hardware connected to the Internet, the software installed on the keyboard 1 automatically runs, allowing telephone conversations/calls through the VoIP technology in a simple and easy way, without the need of additional installations.

Moreover, if the computer is infected with a virus or need maintenance of hardware/software, the user may simply unplug the keyboard 1 from the same and use it on another computer.

The data storage unit 8 is preferably a flash-type memory (EEPROM). However, any other type of memory capable of storing data in digital format can be used, such as ROM or EPROM. The data storage unit 8 may include at least a portion available to the user to read and write digital data, such as digital files containing music, text documents, images, videos, calculating sheets etc., working similar to a flash drive device.

Additionally, the keyboard 1 may have an memory card reader such as SD, MS (Memory Stick), among others.

The main control unit 7 is also operatively associated to a means of receiving sound 4 and a means of emitting sound 5 that, in turn, are preferably controlled by a audio control unit 10 operatively associated with such means. This audio control unit 10 is able to control the functions of the means of receiving sound 4 and the means of emitting sound 5 from instructions from the software communication of the main control unit 7. Optionally, the audio control unit 10 can be integrated into the main control unit 7.

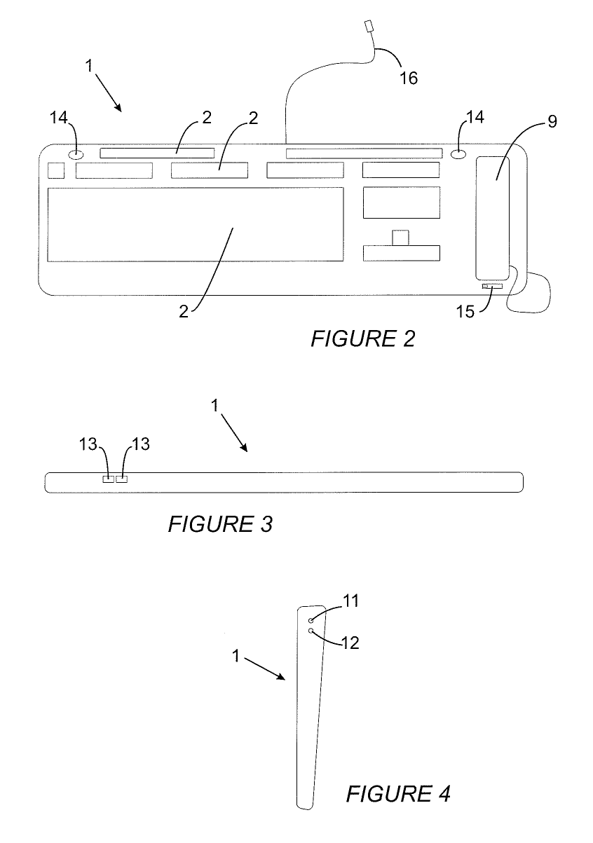

Preferably, the means of receiving sound 4 and the means of emitting sound 5 are integrated in a telephone handset device 9, illustrated in FIGS. 2 and 3. The telephone handset device 9 can be of kind wired or wireless.

In this case, the data storage memory 8 includes a control software of the telephone handset 9 capable of detecting the withdrawal of the telephone handset and enabling the user to automatically start the communication software.

Although in the preferred way, the firmware, the communication software and the telephone handset 9 control software are included in one integrated software, stored in data storage unit 8. This integration facilitates an eventual update process (upgrade of the firmware and/or software) that may be necessary in order to provide functional improvements to the user's keyboard 1. This update can be done, for example, over the Internet.

The audio control unit 10 is still associated with a pair of speakers 14 capable of allowing a conversation.

As seen in FIG. 4, the keyboard 1 also includes at least one auxiliary audio input 11 that allows the docking of external devices to receive sound (microphones, sound sensors, etc.) and an auxiliary audio output 12 suitable for plugging external devices for emitting audio (headphones, speakers, etc.). The auxiliary audio input 11 and the auxiliary audio output 12 are operatively linked to the audio control unit 10.

FIG. 2 illustrates a tuner 15 to allow the selection of the medium of sound emission (telephone handset 9, speaker 14 or auxiliary audio output 12) by the user manually.

Additionally, the keyboard 1 may comprise various multimedia control functions operatively associated with the audio control unit 10, such as a manual volume control, a mute key, among other functions. Furthermore, the keyboard 1 may comprise functions of conventional phones as call forwarding; call waiting, conference call, redial, auto-answer, auto-busy, etc. Also, the keyboard 1 can also function as a digital music player (MP3, WMA, WAV, FLAC, SHN, etc.).

The audio control unit 10 can still run additional functions such as noise reduction, automatic gain control (volume), acoustic echo cancellation, adaptive buffer, etc.

As seen in FIG. 3, the keyboard 1 includes at least an additional interface 13 compatible with the communication pattern (USB 1.1 or 2.0). Thus, the additional interface 13 can allowing the coupling of the external equipment 3 to a device compatible with USB standard, such as flash drives, digital music players (MP3, WMA, etc.), digital cameras, digital camcorders, mobile telephones, etc. Thus, the keyboard 1 also works similarly to a USB hub, so as to extend the USB connections options available to the user, this feature being useful for old computers.

An example of preferred embodiment has been described. Therefore, it should be understood that the scope of this invention covers other possible variations, being limited only by the content of the following claims, in which are possible equivalent are intended to be included.

What is claimed is:

1. Keyboard with integrated telephone service, the keyboard being coupled to external equipment connectable to a communication network compatible with an Internet Protocol, the keyboard comprising keys that allow sending commands to the external equipment, the keyboard having at least:
a means for receiving sound;
a means for emitting sound;
an interface unit that allows coupling of the keyboard to the external equipment and
a main control unit operatively associated with the keys, the means for receiving sound, the means for emitting sound and the interface unit,
the keyboard further comprising at least one data storage unit operatively associated with the main control unit, the data storage unit having a firmware and a communication software that can be automatically run by the main control unit when the keyboard is coupled to the external equipment, the firmware being able to provide identification of the keyboard by the external equipment, the communication software having an algorithm for voice over Internet Protocol that allows a conversation in real time between a user of the keyboard and at least one other user of the communication network.

2. The keyboard of claim 1, wherein the main control unit comprises a microprocessor or a microcontroller.

3. The keyboard of claim 1, wherein the interface unit is compatible with a Universal Serial Bus standard.

4. The keyboard of claim 1, wherein the interface unit is compatible with a wireless communication standard.

5. The keyboard of claim 1, wherein the means for receiving sound and the means for emitting sound are integrated in a telephone handset device.

6. The keyboard of claim 5, wherein the data storage unit includes a software for controlling the telephone handset that is able to detect the removal of the telephone handset by the user and enabling automatically the start of the communication software.

7. The keyboard of claim 1, further comprising at least one additional interface compatible with a Universal Serial Bus communication standard, the additional interface being able to allow coupling of the external equipment with a device compatible with the Universal Serial Bus communication standard.

8. The keyboard of claim 1, wherein at least a portion of the data storage unit is accessible to the user to read and write different digital data.

9. The keyboard of claim 1, further comprising at least one audio control unit operatively associated to the means for receiving sound and means for emitting sound, the audio control unit being able to control the means for receiving sound and the means for emitting sound from instructions of the communication software.

10. The keyboard of claim 9, further comprising at least one auxiliary audio input suitable for plugging external devices for receiving sound, the auxiliary audio input being operatively associated with the audio control unit.

11. The keyboard of claim 9, further comprising at least one auxiliary audio output suitable for plugging external devices for emitting sound, the auxiliary audio output being operatively associated with the audio control unit.

12. The keyboard of claim 9, further comprising multimedia control functions operatively associated with the audio control unit.

13. The keyboard of claim 6, wherein the firmware, the communication software and the software for controlling the telephone handset are included in a single integrated software.

14. The keyboard of claim 1, further comprising a plurality of interface units.

15. The keyboard of claim 1, wherein the communication network is an Internet.
